(19) United States
(12) Patent Application Publication
(10) Pub. No.: US 2025/0124462 A1
(43) Pub. Date: Apr. 17, 2025

(54) METHOD FOR PROVIDING A SURVEY OF A PLURALITY OF PERSONS BY A SURVEY SYSTEM, A CORRESPONDING COMPUTER PROGRAM PRODUCT, A CORRESPONDING COMPUTER-READABLE STORAGE MEDIUM, AS WELL AS A CORRESPONDING SURVEY SYSTEM

(71) Applicant: Siemens Aktiengesellschaft, Munchen (DE)

(72) Inventors: Christian Körner, Bergen (DE); Reinhold Plösch, Linz (AT); Simon Vamberszky, Linz (AT)

(21) Appl. No.: 18/378,726

(22) Filed: Oct. 11, 2023

(51) Int. Cl. G06Q 30/0203; G06F 21/62

(52) U.S. Cl. CPC G06Q 30/0203; G06F 21/6254

(57) ABSTRACT

The method relates to a survey of a plurality of persons by a survey system, comprising: providing the survey to be edited by at least one person of the plurality of persons by a central electronic computing device; modifying the survey; transmitting the modified survey for editing the modified survey; receiving an input for editing the survey by the local electronic computing device; aggregating the modified survey and the input to an aggregated survey; transmitting the aggregated survey to the central electronic computing device by the local electronic computing device; and providing the aggregated survey for a further central electronic computing device of the survey system depending on a privacy related release criterion by the central electronic computing device. Furthermore, the invention relates to a computer program product, a computer-readable storage medium, as well as to a survey system.

### FIELD OF TECHNOLOGY

The present invention relates to a method for providing a survey of a plurality of persons by a survey system according to pending claim 1. Furthermore, the present invention relates to a corresponding computer program product, a corresponding computer-readable storage medium, as well as to a corresponding survey system.

### BACKGROUND

With the current security mechanism system owners can find privacy data in the information system. This renders self-assessment system practically useless as managers may always dig out the individual inputs and punish the individual for it. This behavior is to be taken for granted with current management. To self-assessment systems viable the system needs to be designed in a way to make this impossible.

Organizational solutions to the data privacy problem cannot be trusted so they need to be backed up, in particular enforce, by technical solutions to prevent deanonymization and disaggregation. There is also the issue about a general data protection regulation and workers council consent to be regarded to make self-assessment systems viable.

Also, statistical information and administration information for the respective survey need to be considered to a certain result quality to make the survey worthwhile. So, a delicate balance between the data privacy and business interests needs to be found.

Therefore, a need for a new data privacy solution in a business context arises.

Currently, no technical solution is known. Organizational solutions are attempted by placing the responsibility for the survey and the respective data into another organization and thereby out of the manager's reach. However, this has the disadvantage that the manager may feel judged from outside and try to sabotage the assessment by every means possible. Furthermore, to that it is not a real self-assessment anymore as the assessment is conducted by a third party.

The usually proposed encryption approaches are undermined for so-called security reasons. The organizations select the encryption approaches and issue the certificates so clearly they have access to the data, and therefore, no privacy is possible.

### SUMMARY

It is an object of the invention to provide a method, a corresponding computer program product, a corresponding non-transitory computer-readable storage medium, as well as a corresponding survey system, by which privacy of the data can be realized.

This object is solved by a method, a corresponding computer program product, a corresponding computer-readable storage medium, as well as a corresponding survey system.

One aspect of the invention relates to a method for providing a survey of a plurality of persons by a survey system. The survey is provided to be edited by at least one person of the plurality of persons by a central electronic computing device of the survey system. The survey is modified by adding a modifying information to the survey by the electronic computing device. The modified survey is transmitted to at least one local electronic computing device of the survey system for editing the modified survey by at least one person. An input of the at least one person for editing the at least one survey is received by the local electronic computing device. The modified survey and the input is aggregated to an aggregated survey by the local electronic computing device. The aggregated survey is transmitted to the central electronic computing device by the local electronic computing device. The aggregated survey is provided for another central electronic computing device of the survey system depending on a privacy related release criterion by the central electronic computing device.

Therefore, privacy of the edited survey, in particular of the data, can be realized by the method.

In particular, overall, the privacy is ensured by the users/persons. They use their own encryption keys and decide themselves guided by the survey system when it is safe to publish the aggregated data, in particular consent based. A team may decide when a survey takes place such that the management cannot spoil the result by mandating a certain voting behavior beforehand.

In particular, the focus of the method is on the information privacy. No private data is ever stored on the central electronic computing device, whether encrypted or not. Furthermore, no data can directly or indirectly lead to the identification of individuals actively participating in the survey. It is not stored on the central electronic computing device. A questionnaire must not be stored on the central electronic computing device as it could be a person to deduct individual responsible for answers without their knowledge. An evaluation and privacy relevant decision must be separated out such that they can be assigned to a person independent of an organization management. Furthermore, the system is hardened to men in the middle attacks, by never sending privacy data over the network or avoid communication patterns that allow to deduct the actual survey participants. Furthermore, attempts of breaches are audited.

In particular the proposed method has the advantage that no privacy data is revealed outside the individually controlled local information systems. The survey can be set up and run by internal teams and avoid third party organizations and their systems that propose an additional technical effort and risk. Furthermore, breaches into individual systems can only reveal the individual data processed there. Furthermore, breaches of company security system by informed individuals do not reveal privacy data.

In particular, by the proposed method, a separation of data for a strictly need to know basis is performed. Furthermore, a separation of roles and using role-specific information storage is provided. Private data is strictly local to the individual/person kept. Furthermore, using standardized messages that do not reveal their proposal by size and address is performed. The content is obfuscated. An aggregation in consent principle for each individual part is provided.

In particular, the method can be used because business agility requires frequent high-quality feedback by all participants. Without absolutely respecting privacy this was not possible according to the state-of-the-art law without high expenses of hiring third parties. Internally conducted surveys would have violated workers council regulation and privacy regulations as a manager could get inside into personal rating and use them at least for performance evaluation.

According to an embodiment the release criterion is a predefined amount of distinct participants who edited the survey. Therefore, when a distinct amount of participants has edited the survey, the survey can be released to the further central electronic computing device. Therefore, it is ensured, that only aggregated data is provided to the further central electronic computing device. Therefore, privacy data is not traceable for the further central electronic computing device.

In another embodiment each aggregated survey is released individually by each person. Therefore, each person can individually decide whether the edited survey is transmitted to the central electronic computing device. Therefore, privacy data can be secured.

In another embodiment each person is invited for participation by the electronic computing device. Therefore, it is provided, that only persons, which are invited to the survey, can get an access to the survey. For example, the invitation can be transmitted via an E-mail. Therefore, it is ensured that only persons, who are invited, may edit the survey.

In another embodiment each survey for each person is individualized depending on the roles of the person in the organization. For example, a team leader of a team may get different questions in the survey than team members of the team. Furthermore, also team members may have different roles in the team, and therefore, may get different questions in the survey. Therefore, a secure way for securing privacy data is provided.

According to another embodiment the aggregated survey is securely encrypted before transmitting to the central electronic computing device. In particular, own encryption keys on the local electronic computing device may be used for the aggregated survey. Therefore, the aggregated survey can be transmitted in a safe manner to the central electronic computing device.

According to another embodiment the modifying information is an initial aggregation of the survey. For example, if no person has edited the survey, yet the survey may be transformed such, that the non-edited survey cannot be decrypted by third parties. In particular, the modifying information is known by the central electronic computing device. After editing the survey by the first person and aggregating it, the aggregated survey can be transmitted to the central electronic computing device. By knowing the modifying information, the aggregated survey can be transformed back again by taking into account the modifying information. Therefore, only aggregated data is transmitted via the network and therefore a high security for privacy data is provided.

In another embodiment private data of a person is just released via the transmitted, aggregated survey, if the person approves the private data release. Therefore, just if the person approves the private data release, the private data of the person is released. Therefore, the person can decide, if he wants to release private data. Therefore, a high security for private data is provided.

In another embodiment data of a person is anonymized in each survey before aggregating. Therefore, before aggregating, also the private data is anonymized. Therefore, before aggregating, the anonymization takes part. Therefore, a high security for the private data is provided.

According to another embodiment an incompletely edited survey is received and aggregated by the electronic computing device. For example, the person may not edit the survey completely. Therefore, it is possible that also the incompletely edited survey is aggregated at the local electronic computing device and then transmitted to and received by the central electronic computing device.

Furthermore, after a first reception of the aggregated survey edited by at least one person, this aggregated survey is transmitted to at least a second person as the modified survey to be edited by the second person. Therefore, the second person may get the aggregated survey from the central electronic computing device. Because the aggregated survey is already aggregated by the local electronic computing device of the first person, no modifying information is needed to modify the survey again. Therefore, an easy way for providing the aggregated survey for a second person is provided.

In another embodiment a peer-to-peer architecture between each person and the central electronic computing device is provided. Peer to peer means in this context that there is no central device. This can be achieved by setting up the function of the central electronic computing device on a local device. This provides a secure way for transmitting the survey between the local electronic computing device and the central electronic computing device.

In particular, the method is a computer-implemented method. Therefore, another aspect of the invention relates to a computer program product comprising program code means for performing a method according to the preceding aspect.

A still further aspect of the invention relates to a computer-readable storage medium comprising at least the computer program product according to the preceding aspect.

Furthermore, the invention relates to a survey system for providing a survey of a plurality of persons, comprising at least one local electronic computing device, one central electronic computing device, and one further central electronic computing device, wherein the survey system is configured for performing a method according to the preceding aspect. In particular, the method is performed by the survey system.

Advantageous embodiments of the method are to be regarded as advantageous embodiments of the computer program product, the computer-readable storage medium, as well as the survey system. The survey system therefore comprises means for performing the method according to the preceding aspect.

A computing unit may in particular be understood as a data processing device, which comprises processing circuitry. The computing unit can therefore in particular process data to perform computing operations. This may also include operations to perform indexed accesses to a data structure, for example a look-up table, LUT.

In particular, the computing unit may include one or more computers, one or more microcontrollers, and/or one or more integrated circuits, for example, one or more application-specific integrated circuits, ASIC, one or more field-programmable gate arrays, FPGA, and/or one or more systems on a chip, SoC. The computing unit may also include one or more processors, for example one or more microprocessors, one or more central processing units, CPU, one or more graphics processing units, GPU, and/or one or more signal processors, in particular one or more digital signal processors, DSP. The computing unit may also include a physical or a virtual cluster of computers or other of said units.

In various embodiments, the computing unit includes one or more hardware and/or software interfaces and/or one or more memory units.

A memory unit may be implemented as a volatile data memory, for example a dynamic random access memory, DRAM, or a static random access memory, SRAM, or as a non-volatile data memory, for example a read-only memory, ROM, a programmable read-only memory, PROM, an erasable programmable read-only memory, EPROM, an electrically erasable programmable read-only memory, EEPROM, a flash memory or flash EEPROM, a ferroelectric random access memory, FRAM, a magnetoresistive random access memory, MRAM, or a phase-change random access memory, PCRAM.

For use cases or use situations which may arise in a method according to the invention and which are not explicitly described herein, it may be provided that, in accordance with the method, an error message and/or a prompt for user feedback is output and/or a default setting and/or a predetermined initial state is set.

Further features and feature combinations of the invention are obtained from the figures and their description as well as the claims. In particular, further implementations of the invention may not necessarily contain all features of one of the claims. Further implementations of the inventions may comprise features or combinations of features, which are not recited in the claims.

Independent of the grammatical term usage, individuals with male, female or other gender identities are included within the term.

### BRIEF DESCRIPTION

The figures show in:

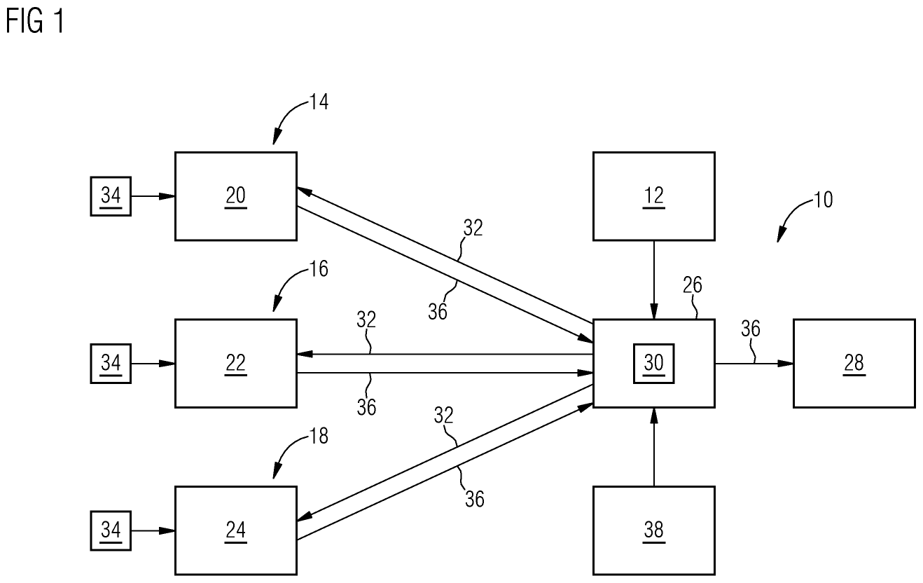

FIG. 1 shows a schematic block diagram according to an embodiment of a survey system; and

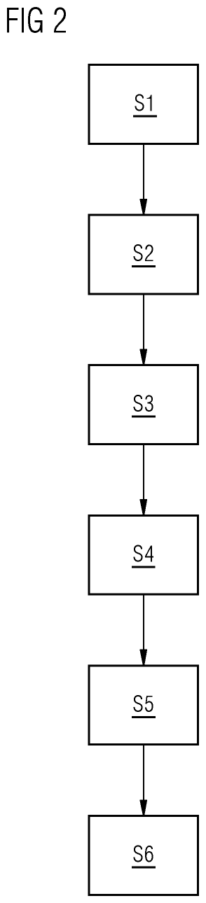

FIG. 2 shows a schematic flow chart according to an embodiment of the method.

### DETAILED DESCRIPTION

In the following, the invention will be explained in detail with reference to specific exemplary implementations and respective schematic drawings. In the drawings, identical or functionally identical elements may be denoted by the same reference signs. The description of identical or functionally identical elements is not necessarily repeated with respect to different figures.

FIG. 1 shows a schematic block diagram according to an embodiment of a survey system 10. The survey system 10 is configured for providing a survey 12 of a plurality of persons 14, 16, 18. The survey system 10 comprises at least one local electronic computing device 20, 22, 24, one central electronic computing device 26 and one further central electronic computing device 28.

For example, a first person 14 may edit the survey 12 at a first local electronic computing device 20. A second person 16 may edit the survey 12 on a second local electronic computing device 22. A third person 18 may edit the survey 12 on a third local electronic computing device 24. The first person 14, the second person 16, as well as the third person 18 may be persons 14, 16, 18 from a team in an organization. The central electronic computing device 26 may for example be an electronic computing device from a team leader. The further central electronic computing device 28 may be an electronic computing device from a manager of the organization.

With the shown survey system 10 a method for providing the survey 12 for the plurality of persons 14, 16, 18 is provided. The survey 12 is provided to be edited by at least one person 14, 16, 18 of the plurality of persons 14, 16, 18 by the central electronic computing device 26. The survey 12 is modified by adding a modifying information 30 to the survey 12 by the central electronic computing device 26. The modified 32 is transmitted to the at least one local electronic computing device 20, 22, 24 for editing the modified survey 32 by at least one person 14, 16, 18. An input 34 of at least one person 14, 16, 18 for editing the at least one survey 12 is received by the local electronic computing device 20, 22, 24. The modified survey 32 and the input 34 is aggregated to an aggregated survey 36 by the local electronic computing device 20, 22, 24. The aggregated survey 36 is transmitted to the central electronic computing device 26 by the local electronic computing device 20, 22, 24. The aggregated survey 36 is provided for the further electronic computing device 28 depending on a privacy related release criterion 38 by the central electronic computing device 26.

In particular, FIG. 1 shows, that after a first reception of the aggregated survey 36 by at least one person 14, 16, 18, this aggregated survey 36 is transmitted to at least the second person 16 as the modified survey to be edited by the second person 16.

Furthermore, the release criterion 38 may be a predefined amount of distinct participants, who edited the survey 12. Furthermore, each aggregated survey 36 is released individually by each person 14, 16, 18. Furthermore, each person 14, 16, 18 may be invited for participation by the central electronic computing device 26.

Furthermore, each survey 12 for each person 14, 16, 18 may be individualized depending on the roles of the person 14, 16, 18 in the organization. Furthermore, the aggregated survey 36 is securely encrypted before transmitting to the central electronic computing device 26. Furthermore, the modifying information 30 is an initial aggregation of the survey 12.

According to another embodiment private data of a person 14, 16, 18 is just released via the transmitted, aggregated surveys 36, if the person 14, 16, 18 approve the private data release. Furthermore, data of a person 14, 16, 18 is anonymized in each survey 12 before aggregating. In another embodiment an incompletely edited survey 12 is received by the central electronic computing device 26. Furthermore, a peer-to-peer architecture between each person 14, 16, 18 and the central electronic computing device 26 is provided.

In particular FIG. 1 shows, that overall the privacy is ensured by the persons 14, 16, 18. They use their own encryption keys and decide themselves guided by the survey system 10 when it is safe to publish the aggregated data, in particular consent based. A team may decide when a survey 12 takes place such that a management cannot spoil the result by mandating a certain voting behavior beforehand.

FIG. 2 shows a schematic flow chart according to an embodiment of the method. In a first step S1 the survey 12 may be set up. In a second step S2 the participants/persons 14, 16, 18 may be invited. In a third step S3 each person 14, 16, 18 may fill in participant data, and a data aggregation may be provided and a consent to private data release, in particular conditional, formed. In a fourth step S4 a data evaluation may be performed. In a fifth step S5 a decision about additional participants or closing the survey 12 is performed. In a sixth step S6 the survey 12 is closed.

According to the shown method persons 14, 16, 18, which may participate at the survey 12 may be the so-called survey supporters, counseling/mediating persons and presenters.

According to the provided survey system 10 the survey system 10 may use client modules for information processing and server modules for e-mail, security services, auditing, software distribution and ALM-systems for document access.

Via the client modules the server setup and the participants invitation may be performed. The client modules may be configured for setting up the participants, processing the questionnaire, and consenting. Furthermore, the client modules may be configured for evaluating the response quality of evaluation, the aggregation and assuring the response quality.

The server modules may be used and may not hold any privacy data. The server modules may offer security services, and data distribution services. ALM repo, software distribution, security server, audit, and mail server may be provided as a server module. As already mentioned, additionally to the client modules the security module and audit module may be included in the client and work in a peer-to-peer mode.

The ALM repo server may be an application lifecycle for a management repository. This module stands for a plethora of services holding artifacts for the software application management lifecycle. This artifacts are referenced by the participants and the evaluator to back up the assessment rating.

The software distribution module is like an antifactory of the ALM server that hold the self-assessment service client runtime. Preferable in an encrypted way for suitable standard virtual machines that support sandboxing.

The security server is a special server sorting the participants and the surveys credentials. It initializes each survey 12 and allows access only to survey participants. The main function is to provide obfuscation data for additional security of data transactions among the survey participants. It does not store any secrets used to create obfuscating data.

The client module is made for initiating the survey 12. The client modules may load to the questionnaire, determine a scope of participants, in particular excluding managers, point active participants and the question set. The client modules may set up security servers with survey credentials and part lists. The client modules may notify participants and appoint evaluator and consultants. Furthermore, the invitation is sent via the client modules.

Furthermore, the evaluate survey module may collect quality data and determine aggregation level and in case of insufficient quality invite for answering for more questions, furthermore, and may active more of the participants. The evaluate survey module may initiate consent to aggregated data by active participants. The evaluate survey module may unconsent of all active participants release aggregated data to all survey participants and terminate the survey.

The questionnaire-fill in module may fill the survey responses and send quality data to the evaluator. On request of the evaluator the questionnaire-fill in module may consent to the aggregated data release.

The consult participants module may help with the survey individually on invitation by active participants. The consultant must not have management roles.

The set-up client module may set up the client with credentials upon invitation and may role off the survey. The set-up client module may provide personal security credentials to the security server.

In other words, the invention provide high quality customized organization self-service surveys without compromising data privacy. Actual participants data is not stored or communicated by the system separately. Even a break into reveals nothing only very partial information. Privacy data like actual answers to the question are never stored on central systems or sent over the network. Resulting data is validated against factual information without revealing the individual ratings. Participants can get consultation for answering the questions without revealing the actual ratings or even participation in the survey 12. Aggregated data is never sent over the network nor stored in the central server before all participants consent to release it. Aggregated data is checked and hardened against disaggregation before the actual aggregation really happens.

The survey system 10 is hardened to man in the middle attacks. Individual rating data in never sent over the network only aggregated data with noise (modifying information) added. Aggregated data is never sent over the network as random noise data is added. Actual participants cannot be detected from communication patterns. An actual participants list is neither stored nor sent over the network. Always a complete data set is sent such that size and sequence do not identify the nature of the data.

### REFERENCE SIGNS

10 survey system
12 survey
14 first person
16 second person
18 third person
20 first local electronic computing device
22 second local electronic computing device
24 third local electronic computing device
26 central electronic computing device
28 further central electronic computing device
30 modifying information
32 modified survey
34 input
36 aggregated survey
38 release criterion
S1-S6 steps of the method

1. A method for providing a survey of a plurality of persons by a survey system, comprising the steps of:
providing the survey to be edited by at least one person of the plurality of persons by a central electronic computing device of the survey system;
modifying the survey by adding a modifying information to the survey by the central electronic computing device;
transmitting the modified survey to at least one local electronic computing device of the survey system for editing the modified survey by at least one person;
receiving an input of the at least one person for editing the at least one survey by the local electronic computing device;
aggregating the modified survey and the input to an aggregated survey by the local electronic computing device;
transmitting the aggregated survey to the central electronic computing device by the local electronic computing device; and
providing the aggregated survey for a further central electronic computing device of the survey system depending on a privacy related release criterion by the central electronic computing device.

2. A method according to claim 1, wherein
the release criterion is a predefined amount of distinct participants, who edited the survey.

3. A method according to claim 1, wherein
each aggregated survey is released individually by each person.

4. A method according to claim 1, wherein
each person is invited for participation by the central electronic computing device.

5. A method according to claim 1, wherein
each survey for each person is individualized depending on the roles of the person in the organization.

6. A method according to claim 1, wherein
the aggregated survey is securely encrypted before transmitting to the central electronic computing device.

7. A method according to claim 1, wherein
the modifying information is an initial aggregation of the survey.

8. A method according to claim 1, wherein
private data of a person is just released via the transmitted, aggregated surveys, if the person approves the private data release.

9. A method according to claim 1, wherein
data of a person is anonymized in each survey before aggregating.

10. A method according to claim 1, wherein
an incompletely edited survey is received by the central electronic computing device.

11. A method according to claim 1, wherein
after a first reception of the aggregated survey edited by at least one person, this aggregated survey is transmitted to at least a second person as the modified survey to be edited by the second person.

12. A method according to claim 1, wherein
a peer-to-peer architecture between each person and the central electronic computing device is provided.

13. A computer program product comprising program code means for performing a method according to claim 1.

14. A computer-readable storage medium comprising the computer program product according to claim 13.

15. A survey system for providing a survey of a plurality of persons, comprising at least one local electronic computing device, one central electronic computing device, and one further central electronic computing device, wherein the survey system is configured for performing the method steps of:
providing the survey to be edited by at least one person of the plurality of persons by a central electronic computing device of the survey system;
modifying the survey by adding a modifying information to the survey by the central electronic computing device;
transmitting the modified survey to at least one local electronic computing device of the survey system for editing the modified survey by at least one person;
receiving an input of the at least one person for editing the at least one survey by the local electronic computing device;
aggregating the modified survey and the input to an aggregated survey by the local electronic computing device;
transmitting the aggregated survey to the central electronic computing device by the local electronic computing device; and
providing the aggregated survey for a further central electronic computing device of the survey system depending on a privacy related release criterion by the central electronic computing device.
